(19) United States
(12) Patent Application Publication
(10) Pub. No.: US 2015/0045083 A1
(43) Pub. Date: Feb. 12, 2015

(54) WIRELESS COMMUNICATION APPARATUS

(71) Applicant: KABUSHIKI KAISHA TOSHIBA, Tokyo (JP)

(72) Inventor: Katsuya NONIN, Kanagawa (JP)

(73) Assignee: KABUSHIKI KAISHA TOSHIBA, Tokyo (JP)

(21) Appl. No.: 14/191,287

(22) Filed: Feb. 26, 2014

(30) Foreign Application Priority Data
Aug. 7, 2013 (JP) 2013-164513

(51) Int. Cl. H04W 52/38

(52) U.S. Cl. CPC H04W 52/383
USPC 455/522

(57) ABSTRACT

A wireless communication apparatus including a first semiconductor integrated circuit and a second semiconductor integrated circuit is provided. The first semiconductor integrated circuit includes an activation control unit that sets a first activation control signal and a second activation control signal in response to whether or not a wake-up signal, and a reception processing unit that transitions into an operation state from a sleep state in response to the first activation control signal and demodulates the wireless signal in the operation state. The second semiconductor integrated circuit transitions into an operation state from a sleep state in response to the second activation control signal, and processes a demodulated signal which is output from the first semiconductor integrated circuit in the operation state.

### CROSS-REFERENCE TO RELATED APPLICATION

This application is based upon and claims the benefit of priority from Japanese Patent Application No. 2013-164513, filed Aug. 7, 2013, the entire contents of which are incorporated herein by reference.

### FIELD

Embodiments described herein relate generally to a wireless communication apparatus.

### BACKGROUND

A wireless communication apparatus, which is configured with a RFIC for wireless communication and a Multiple Control Unit (MCU) that interprets an output, is known in the art. In the wireless communication apparatus in which a low power consumption operation is required, a wake-up signal detection unit which detects a wake-up signal contained in the wireless signal is provided inside the semiconductor integrated circuit. Then, until the wake-up signal is detected, other functional units (a reception processing unit which receives a wireless signal and the like) and the MCU inside the semiconductor integrated circuit are set to a sleep mode.

Generally, if the wake-up signal is detected, a wake-up signal detection unit activates an MCU, first, and then the activated MCU activates the entire semiconductor integrated circuit. In this case, the sum of a time necessary for activating the MCU and a time necessary for activating the entire semiconductor integrated circuit must be less than the continuation time of the wake-up signal. Otherwise, the wireless communication apparatus cannot correctly receive the data subsequent to the wake-up signal.

In view of the above described constraint, there may be a problem when an expensive MCU capable of being activated in a short time is used.

### DESCRIPTION OF THE DRAWINGS

FIG. 1 is a block diagram showing a schematic configuration of a wireless communication apparatus according to a first embodiment.

FIG. 2 is a diagram showing an example of a configuration of a wireless signal.

FIG. 3 is a sequence diagram showing a processing operation of each unit inside the wireless communication apparatus.

FIG. 4 is a diagram schematically showing a transition of each signal, and a transition of a state of a transceiving processing unit and a MCU.

FIG. 5 is a block diagram showing a schematic configuration of a wireless communication apparatus according to a second embodiment.

FIG. 6 is a flow chart showing an example of a processing operation of the wireless communication apparatus of FIG. 5.

### DETAILED DESCRIPTION

Embodiments provide a wireless communication apparatus capable of being activated in a short time from detection of the wake-up signal.

In general, according to one embodiment, a wireless communication apparatus including a first semiconductor integrated circuit and a second semiconductor integrated circuit is provided. The first semiconductor integrated circuit includes an activation control unit that sets a first activation control signal and a second activation control signal in response to a wake-up signal, and a reception processing unit that transitions into an operation state from a sleep state in response to the first activation control signal and demodulates the wireless signal in the operation state. The second semiconductor integrated circuit transitions into an operation state from a sleep state in response to the second activation control signal, and processes a demodulated signal which is output from the first semiconductor integrated circuit in the operation state.

Hereinafter, embodiments will be described in detail with reference to drawings.

### First Embodiment

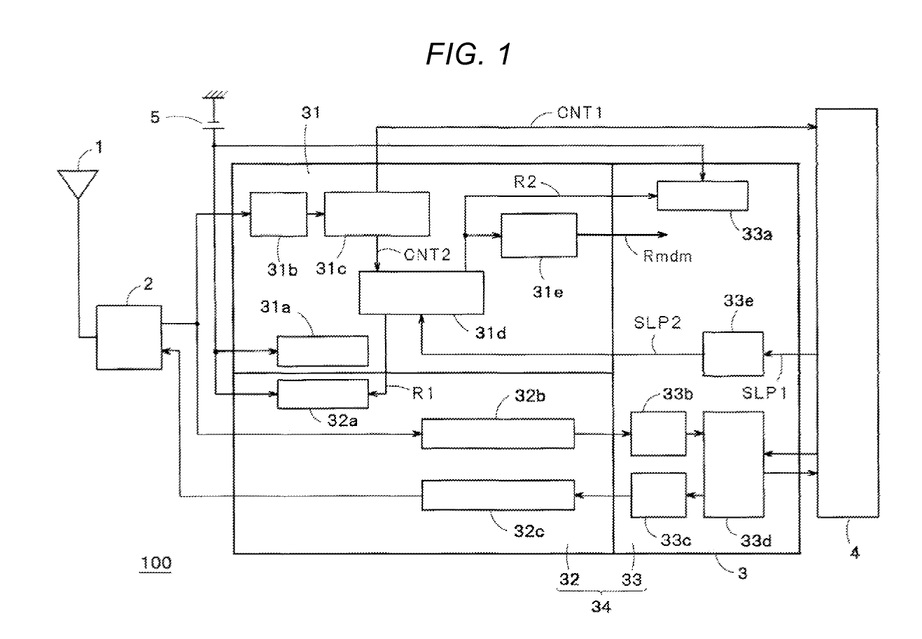

FIG. 1 is a block diagram showing a schematic configuration of a wireless communication apparatus 100 according to a first embodiment. In the present embodiment, an example is shown in which the wireless communication apparatus 100 is mounted on a vehicle and used in an Electronic Toll Collection (ETC) system. In this case, the wireless communication apparatus 100 transmits and receives information necessary for billing with an ETC gate. Specifically, the wireless communication apparatus 100 receives information for specifying the ETC gate from the ETC gate, or transmits information for specifying the vehicle to the ETC gate.

The wireless communication apparatus 100 includes an antenna 1, a switch 2, a Radio Frequency Integrated Circuit (RFIC, first semiconductor integrated circuit) 3, a Multiple Control Unit (MCU, second semiconductor integrated circuit) 4, and a battery 5.

The antenna 1 receives or transmits wireless signals. The switch 2 switches between supplying the wireless signals received by the antenna 1 to the RFIC 3 and receiving the signals from the RFIC 3 for transmission through the antenna 1.

The RFIC 3 transmits information to the ETC gate through the antenna 1. Further, the RFIC 3 converts the wireless signal received by the antenna 1 into a digital signal. The digital signal is sent to the MCU 4 through a Serial Parallel Interface (SPI).

The MCU 4 is implemented by, for example, a semiconductor integrated circuit. Then, the MCU 4 processes a digital signal which is output from the RFIC 3, and interprets its content. Further, the MCU 4 generates a digital signal indicating information to be transmitted from the RFIC 3 to the ETC gate. The digital signal is output to the RFIC 3 through the SPI. When the MCU 4 is temporarily unable to perform a normal operation due to a temperature rise and/or electromagnetic wave interference from the vehicle, a reset IC (not shown) may be provided to reset the MCU 4 periodically. The MCU 4 operates normally again after being reset.

Here, for example, it is assumed that the wireless communication apparatus 100 of FIG. 1 is attached to the windshield of a vehicle and is powered by a battery 5. Therefore, low-power operation is desired in the wireless communication apparatus 100. Further, high-speed operation is desired for transmitting or receiving information between the vehicle traveling at a speed of about 100 km/h past the ETC gate.

Thus, in the present embodiment, until a wake-up signal (described later) is detected from the wireless signal, a part of the RFIC 3 and the MCU 4 are in a sleep state. Then, if the wake-up signal is detected from the wireless signal, the MCU 4 and the sleeping part of the RFIC 3 are activated in parallel. Thus, the whole RFIC 3 is activated in a short time, as compared to a case where the MCU 4 is first activated and then the MCU 4 activates the whole RFIC 3.

Hereinafter, a configuration of a wireless signal received by the wireless communication apparatus 100 is described and subsequently the RFIC 3 is described in detail.

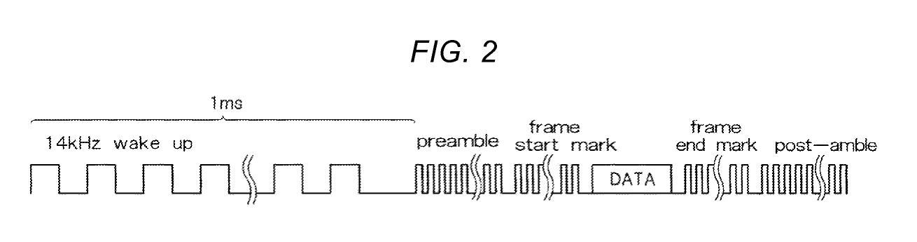

FIG. 2 is a diagram showing an example configuration of a wireless signal to be transmitted from the ETC gate. The wireless signal is, for example, a signal that is frequency modulated. A wake-up signal is a signal that is included at the beginning of the wireless signal and continues for a predetermined time period T1 (for example, about 1 ms). The wireless communication apparatus 100 detects the wake-up signal to recognize that the wireless communication apparatus 100 is approaching the ETC gate. Then, after the wake-up signal, a preamble, a frame start mark, data, a frame end mark, and a post-amble follow. The data includes, for example, information for specifying the ETC gate.

As shown, the wake-up signal has a lower frequency than other signals, for example, about 14 kHz. Accordingly, the wireless communication apparatus 100 detects a signal of a low frequency (in other words, a low bit rate) as a wake-up signal from the wireless signal.

Returning to FIG. 1, the RFIC 3 includes an activation control unit 31, a RF processing unit 32, and a modem 33.

The activation control unit 31 detects a wake-up signal contained in the wireless signal and sets an MCU activation control signal CNT1 and an autonomous activation control signal CNT2 in response to the detection to control the activation of the RF processing unit 32, the modem 33, and the MCU 4. The activation control unit 31 includes a regulator 31a, a detector 31b, a wake-up signal detection unit 31c, a controller 31d, and a modem reset unit 31e.

The regulator 31a regulates power supplied by the battery 5 and powers the detector 31b, the wake-up signal detection unit 31c, and the controller 31d. Each unit within the activation control unit 31 is always activated, i.e., no unit in the activation control unit ever sleeps.

The detector 31b detects the wireless signal.

The wake-up signal detection unit 31c detects the wake-up signal from the detected wireless signal, based on the presence or absence of the low bit rate signal. Then, the wake-up signal detection unit 31c, according to the detection of the wake-up signal, sets the MCU activation control signal CNT1 and the autonomous activation control signal CNT2. More specifically, if the wake-up signal is detected, the wake-up signal detection unit 31c sets the MCU activation control signal CNT1 and the autonomous activation control signal CNT2 to active.

The MCU activation control signal CNT1 is a signal supplied to the MCU 4 to activate the unit. The autonomous activation control signal CNT2 is a signal supplied to the controller 31d to activate the RF processing unit 32 and the modem 33.

The autonomous activation control signal CNT2 and a sleep signal SLP2 from the modem 33 are input to the controller 31d. The controller 31d sets regulator control signals R1 and R2 in response to the autonomous activation control signal CNT2 and the sleep signal SLP2. More specifically, if the autonomous activation control signal CNT2 is set to active, the controller 31d sets the regulator control signals R1 and R2 to active. Further, if the sleep signal SLP2 is set to active, the controller 31d sets the regulator control signals R1 and R2 to non-active. The regulator control signals R1 and R2 are respectively supplied to the regulators 32a and 33a (described later).

The modem reset unit 31e generates a modem reset signal Rmdm for resetting the modem 33 in response to the regulator control signal R2. More specifically, after the regulator control signal R2 is set to active and a predetermined stand-by time has elapsed, the modem reset signal Rmdm is set to active. The modem reset signal Rmdm is supplied to the modem 33.

The RF processing unit 32 and the modem 33 of the RFIC 3 constitute a transceiving processing unit 34 and perform a frequency-conversion, an AD conversion, a DA conversion, a de-modulation, a modulation, and the like of a signal. The RF processing unit 32 includes a regulator 32a, a down-conversion unit 32b, and an up-conversion unit 32c. The modem 33 includes a regulator 33a, a demodulation unit 33b, a modulation unit 33c, a First In First Out (FIFO) 33d, and a controller 33e.

The down-conversion unit 32b, the demodulation unit 33b and the FIFO 33d are used in reception of the wireless signal. That is, the down-conversion unit 32b down-converts the frequency of the wireless signal received by the antenna 1 to an intermediate frequency band or a base band, and performs an A-D conversion. The demodulation unit 33b demodulates the down-converted wireless signal. The demodulated wireless signal is accumulated temporarily in the FIFO 33d, and is read out by the MCU 4 in turn.

On the other hand, the FIFO 33d, the modulation unit 33c and the up-conversion unit 32c are used in transmission of the wireless signal. The signal to be transmitted is written into the FIFO 33d from the MCU 4. The modulation unit 33c modulates the signal which is written in the FIFO 33d in turn. The up-conversion unit 32c converts the modulated signal into an analog signal, and up-converts the frequency into a radio frequency band. The up-converted signal is transmitted from the antenna 1 as the wireless signal.

Further, the controller 33e of the modem 33 sets the sleep signal SLP2 in response to a sleep signal SLP1 from the MCU 4. More specifically, if the sleep signal SLP1 is set to active, the controller 33e sets the sleep signal SLP2 to active. The sleep signal SLP2 is supplied to the controller 31d of the activation control unit 31. The sleep signals SLP1 and SLP2 cause the RF processing unit 32 and the modem 33 inside the RFIC 3 to sleep.

Here, the regulator 32a controls the activation of the RF processing unit 32 in response to the regulator control signal R1. More specifically, until the regulator control signal R1 is set to active, the regulator 32a is off and does not supply power to the down-conversion unit 32b and the up-conversion unit 32c. Accordingly, the RF processing unit 32 is in a sleep state. If the regulator control signal R1 is set to active, the regulator 32a is on and regulates power from the battery 5 to supply power to the down-conversion unit 32b and the up-conversion unit 32c. Thus, the RF processing unit 32 is in the operation state. Then, if the regulator control signal R2 is set to non-active, the regulator 32a is off and the RF processing unit 32 is in the sleep state, again. A small amount of power is consumed in the sleep state and power consumption is at least lower than in operation state.

Further, the regulator 33a controls the activation of the modem 33 in response to the regulator control signal R2. More specifically, until the regulator control signal R2 is set to active, the regulator 33a is off, and does not supply power to the demodulation unit 33b, the modulation unit 33c, the FIFO 33d, and the controller 33e. Accordingly, the modem 33 is in a sleep state. Then, if the regulator control signal R2 is set to active, the regulator 33a is on and regulates power from the battery 5 so as to supply power to the demodulation unit 33b, the modulation unit 33c, the FIFO 33d, and the controller 33e. Thus, the modem 33 is in an operation state. Then, if the regulator control signal R2 is set to non-active, the regulator 33a is off and the modem 33 is in the sleep state, again. A small amount of power is consumed in the sleep state and the consumed power is at least lower than in operation state.

In this manner, if the activation control unit 31 of the RFIC 3 detects the wake-up signal from the wireless signal, the activation control unit 31 autonomously activates the transceiving processing unit 34 inside the RFIC 3. Accordingly, the transceiving processing unit 34 can be rapidly activated upon the detection of the wake-up signal, and can process data of the wireless signal quickly.

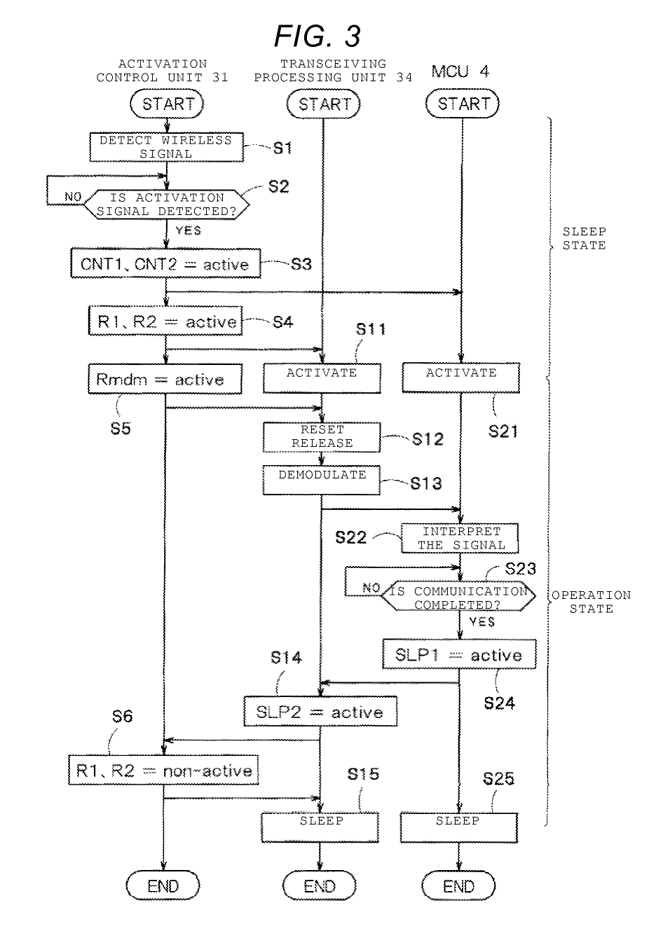

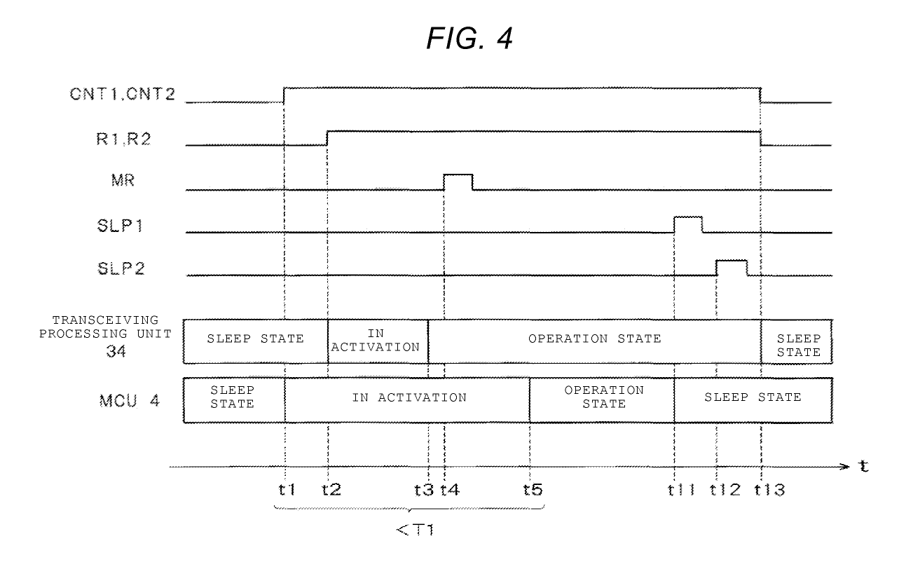

FIG. 3 is a sequence diagram showing a processing operation of each unit inside the wireless communication apparatus 100. Further, FIG. 4 is a diagram that schematically shows transition of each signal and state transitions of the transceiving processing unit 34 and the MCU 4. The drawings show a case where the wireless communication apparatus 100 receives the wireless signal. A processing operation when reception of the wireless communication apparatus 100 will be described using FIGS. 3 and 4.

The detector 31b detects the wireless signal (step S1). Then, if the wake-up signal detection unit 31c detects the wake-up signal from the wireless signal (YES in step S2), the wake-up signal detection unit 31c sets the MCU activation control signal CNT1 and the autonomous activation control signal CNT2 to active (step S3, time t1 of FIG. 4).

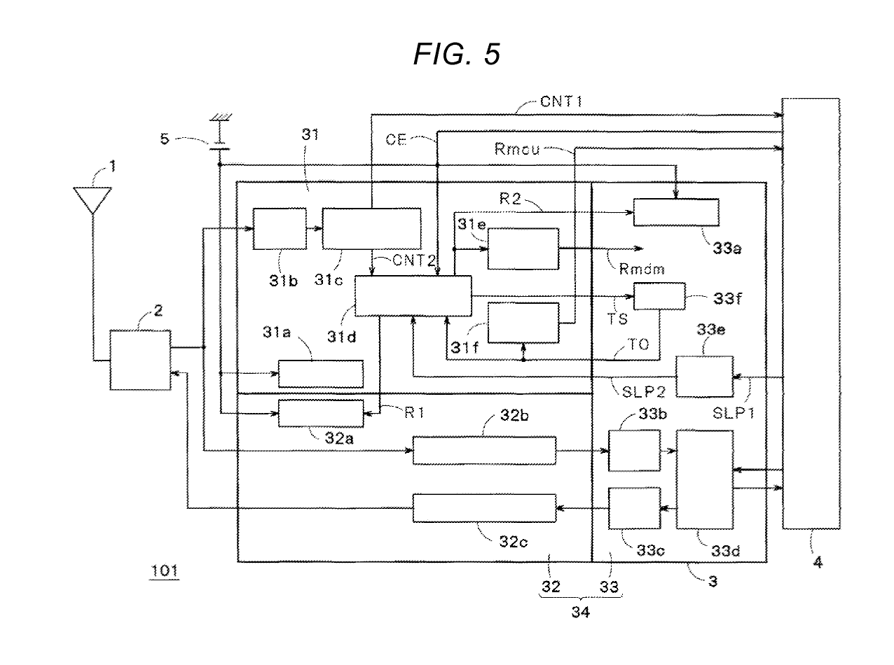

The MCU 4 starts activation in response to the MCU activation control signal CNT1 being set to active (step S21). Then, the MCU 4 is in the operation state, for example, at time t5 of FIG. 5, after a predetermined activation time.

Further, the controller 31d sets the regulator control signals R1 and R2 to active by the autonomous activation control signal CNT2 being set to active (step S4, time t2 of FIG. 4). Accordingly, the regulator 32a of the RF processing unit 32 and the regulator 33a of the modem 33 are on. Thus, the RF processing unit 32 and the modem 33 start activation (step S11). Then, the RF processing unit 32 and the modem 33 are in the operation state, for example, at time t3 of FIG. 5 through a predetermined activation time.

Further, after the regulator control signal R2 is set to active, the modem reset unit 31e is on stand-by for only a predetermined stand-by time, and sets the modem reset signal Rmdm to active (step S5, time t4 of FIG. 4). The stand-by time is determined in view of a time required for power to be supplied stably to the modem 33 from the regulator 33a, that is, the activation time of the modem 33. After the modem reset signal Rmdm being set to active, the reset release of the modem 33 is performed (step S12). Thus, the modem 33 performs the demodulation of wireless signal.

As shown in FIG. 2, the wake-up signal in the wireless signal continues only for a time period T1, and thereafter is followed by a preamble, data, and the like. Therefore, if the transceiving processing unit 34 and the MCU 4 are activated within time period T1 after the wake-up signal is detected at time t1 of FIG. 4, the transceiving processing unit 34 can correctly receive a preamble, data, and the like. In other words, when time t1 to t5 is less than the time period T1, correct reception of the preamble, data and like is assured.

In the method of the related art, since the MCU 4 activates the transceiving processing unit 34 after the activation of the MCU 4, the sum of these activation times (sum of times t1 to t5 and times t2 to t3) needs to be shorter than the time period T1. In contrast, in the present embodiment, each of the activation time (time t1 to t5) of the MCU 4 and the activation time (time t2 to t3) of the transceiving processing unit 34 may be shorter than the time period T1. Accordingly, the activation time of the MCU 4 may be long to some extent, and an inexpensive MCU 4 can be used.

After reset release of the modem 33, the RF processing unit 32 and the modem 33 demodulate the wireless signal received by the antenna 1 (step S13). The signal obtained by the demodulation is output to the MCU 4, and the MCU 4 processes and interprets the signal (step S22).

If the reception of the wireless signal is completed, the MCU 4 sets the sleep signal SLP1 to active (step S23, time t11 of FIG. 4), and causes itself to be in the sleep state (step S24). Whether or not the reception of the wireless signal is completed is determined, for example, based on the frame end mark contained in the wireless signal.

By the sleep signal SLP1 being set to active, the controller 33e of the modem 33 sets the sleep signal SLP2 to active (step S14, time t12 of FIG. 4). Accordingly, the controller 31d of the activation control unit 31 sets the regulator control signals R1 and R2 to non-active (step S6, time t13 of FIG. 4). Therefore, the regulator 32a of the RF processing unit 32 and the regulator 33a of the modem 33 are off. Thus, the RF processing unit 32 and the modem 33 sleep (step S15) and are in the sleep state. In addition, at time t13, the MCU activation control signal CNT1 and the autonomous activation control signal CNT2 are set to non-active as well.

In this manner, in the first embodiment, if the activation control unit 31 detects the wake-up signal from the wireless signal, it activates autonomously the transceiving processing unit 34. The transceiving processing unit 34 can be activated in a short time from the detection of the wake-up signal, as compared to a case where the MCU 4 is activated and then the MCU 4 activates the transceiving processing unit 34.

### Second Embodiment

In a second embodiment described below, after the MCU 4 is activated, a chip enable signal is transmitted to the RFIC 3.

The MCU 4 does not perform a normal operation temporarily due to a temperature rise and/or electromagnetic wave interference from the vehicle in some cases. Even if a reset IC (not shown) resets the MCU 4 periodically, if the MCU 4 does not work normally when the wireless communication apparatus receives a wake-up signal and sets the MCU activation control signal CNT1 to active (time t1 of FIG. 4), the MCU 4 is not activated. On the other hand, the transceiving processing unit 34 is activated in response to the autonomous activation control signal CNT2 (time t4). In this case, since the MCU 4 does not set the sleep signal SLP1 to active, the activated transceiving processing unit 34 does not sleep while remaining in the activated state. As a result, the wireless communication apparatus consumes power needlessly.

Thus, in the present embodiment, if the MCU 4 is activated, the MCU 4 sets the chip enable signal CE to active, indicating that the MCU is activated, and transmits the chip enable signal CE to the RFIC 3. If the chip enable signal is not set to active within a predetermined time period after the wake-up signal is received, the activation control unit 31 causes the transceiving processing unit 34 to sleep. Thus, it prevents the wireless communication apparatus from consuming power needlessly. Further, if the chip enable signal is not set to active within a predetermined time period after the wake-up signal is received, the activation control unit 31 may reset the MCU 4. Thus, the MCU 4 operates normally. Hereinafter, this procedure will be described in more detail.

FIG. 5 is a block diagram showing a schematic configuration of a wireless communication apparatus 101 according to the second embodiment. In FIG. 5, the same reference numerals are assigned to components common to FIG. 1, and the differences will be described mainly in the following.

In the present embodiment, if the MCU 4 is activated, the MCU 4 sets the chip enable signal CE indicating that it is activated to active and transmits the chip enable signal CE to the controller 31d of the RFIC 3. Further, if an MCU reset signal Rmcu transmitted from the RFIC 3 is set to active, the MCU 4 is reset. In addition, if a reset IC (not shown) resets the MCU 4 periodically, the MCU 4 is reset by the MCU reset signal Rmcu, in addition to the periodic reset.

Further, the modem 33 includes a timer 33f. The timer 33f is controlled by the controller 31d of the activation control unit 31. More specifically, if the reset of the modem 33 is released (step S12 of FIG. 3), the timer 33f starts a count-up. If a timer stop signal TS from the controller 31d of the activation control unit 31 is set to active, the timer 33f stops the count-up. If the count value reaches a predetermined value while the timer stop signal TS is not set to active, the timer 33f sets a time-out signal TO to active.

If the time-out signal TO is set to active, the controller 31d sets the regulator control signals R1 and R2 to non-active. Thus, the regulators 32a and 33a are off, and the transceiving processing unit 34 is in the sleep state.

In addition, it is desirable to locate the timer 33f inside the modem 33, instead of the activation control unit 31. The reason is that if the timer 33f is located inside the activation control unit 31, the timer 33f is always active and consuming power.

Further, the activation control unit 31 includes a MCU reset unit 31f which sets the MCU reset signal Rmcu. If the time-out signal TO is set to active, the MCU reset unit 31f sets the MCU reset signal Rmcu to active. Thus, the MCU 4 is reset.

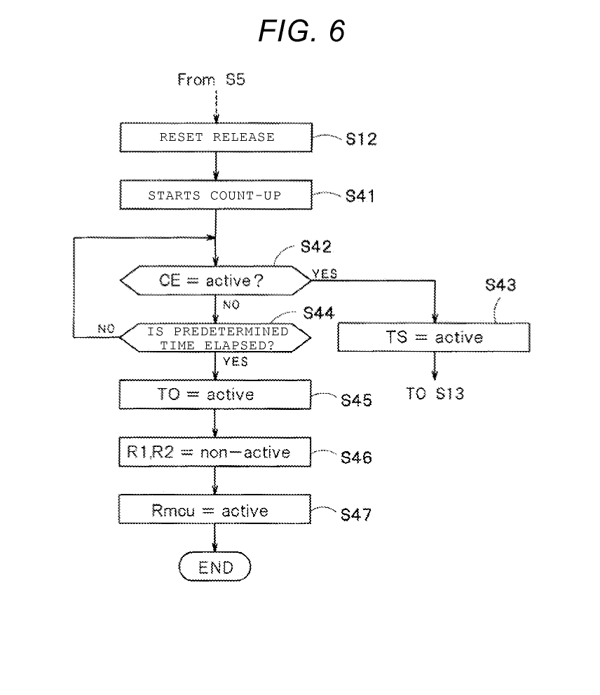

FIG. 6 is a flow chart showing an example of a processing operation of the wireless communication apparatus 101 of FIG. 5. The processing operations in FIG. 6 are performed after steps S5 and S11 of FIG. 3, and drawn in a simplified manner.

If the reset is released by the modem reset unit 31e (step S12), the timer 33f of the modem 33 starts the count-up (step S41). If the MCU 4 operates normally and is activated in response to the MCU activation control signal, the chip enable signal CE is set to active by the MCU 4. If the chip enable signal CE is set to active (YES of step S42), the controller 31d inside the activation control unit 31 sets the timer stop signal TS to active (step S43), and stops the timer 33f. Thereafter, the transceiving processing unit 34 performs the process after step S13 of FIG. 3.

On the other hand, if the MCU 4 is temporarily unable to perform a normal operation, the chip enable signal CE is not set to active (NO in step S42 and YES in S44). If the chip enable signal CE is not set to active while waiting for a predetermined time (YES in step S43), the timer 33f sets the time-out signal TO to active (step S45). Accordingly, the controller 31d of the activation control unit 31 sets the regulator control signals R1 and R2 to non-active (step S46). Thus, the transceiving processing unit 34 is in the sleep state. Further, the MCU reset unit 31f sets the MCU reset signal Rmcu to active (step S47). Thus, the MCU 4 is reset.

In this manner, in the second embodiment, if the MCU 4 is activated, it sends a chip enable signal CE to the RFIC 3. If the chip enable signal CE is not set to active within a predetermined time period, the RFIC 3 causes the transceiving processing unit 34 to sleep. Thus, it prevents the power from being wasted when the MCU 4 is not activated. In addition, the activation control unit 31 generates a MCU reset signal Rmcu to return the MCU 4 to a normal state.

In addition, although the wireless communication apparatuses 100 and 101 perform both transmission and reception in each embodiment described above, they may perform only reception.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a first semiconductor integrated circuit; and
a second semiconductor integrated circuit,
wherein the first semiconductor integrated circuit includes:
an activation control unit that sets a first activation control signal and a second activation control signal in response to whether or not a wake-up signal is detected; and
a reception processing unit that transitions into an operation state from a sleep state in response to the first activation control signal and demodulates the wireless signal in the operation state, and
wherein the second semiconductor integrated circuit transitions into an operation state from a sleep state in response to the second activation control signal, and processes a demodulated signal which is output from the first semiconductor integrated circuit in the operation state.

2. The apparatus according to claim 1,
wherein the reception processing unit is in the sleep state when the first activation signal is at a first level and transitions into the operation state when the first activation control signal is at a second level, and
the second semiconductor integrated circuit is in the sleep state when the second activation signal is at a first level and transitions into the operation state when the second activation control signal is at a second level.

3. The apparatus according to claim 1,
wherein the reception processing unit is in the sleep state until the first activation signal is set by the activation control unit, and
wherein the second semiconductor integrated circuit is in the sleep state until the second activation signal is set by the activation control unit.

4. The apparatus according to claim 1,
wherein the reception processing unit includes:
a down-conversion unit that down-converts a frequency of the wireless signal;
a demodulation unit that demodulates an output of the down-conversion unit; and
a regulator that is configured to supply power to the down-conversion unit and the demodulation unit to cause the reception processing unit to transition from the sleep state into the operation state.

5. The apparatus according to claim 1,
wherein the wake-up signal continues for at least a first time period, and
wherein the reception processing unit and the second semiconductor integrated circuit are enabled to transition into the operation state within the first time period when the wake-up signal is detected by the activation control unit within the first time period.

6. The apparatus according to claim 1, wherein
the second semiconductor integrated circuit is configured to send an enable signal to the reception processing unit; and
the reception processing unit transitions to the sleep state if the enable signal is not received after a certain time following the wake-up signal.

7. The apparatus according to claim 6, wherein the activation control unit resets the second semiconductor integrated circuit after placing the reception processing unit into the sleep state.

8. A wireless communication apparatus comprising:
a wireless transceiver device that includes a reception processing unit, and an activation control unit that generates a first activation control signal and a second activation control signal in response to a wake-up signal detected in a wireless signal, wherein the reception processing unit is configured to transition from a sleep state to an operation state in response to the first activation control signal, and generate a demodulated output of the wireless signal while in the operation state; and
a multiple control unit configured to transition from a sleep state to an operation state in response to the second activation control signal, and process the demodulated output of the wireless signal while in the operation state.

9. The apparatus according to claim 8, wherein the activation control unit generates the first activation control signal and the second activation control signal at or nearly at the same time.

10. The apparatus according to claim 8, wherein
the wake-up signal continues for a certain time period; and
the reception processing unit and the multiple control unit are enabled to transition into the operation state when the wake-up signal is received by the activation control unit within the certain time period.

11. The apparatus according to claim 8, wherein
the multiple control unit is configured to send an enable signal to the reception processing unit; and
the reception processing unit transitions to the sleep state if the enable signal is not received after a certain time following the wake-up signal.

12. The apparatus according to claim 11, wherein the activation control unit resets the multiple control unit after placing the reception processing unit in the sleep state.

13. The apparatus according to claim 8, wherein the reception processing unit includes a regulator configured to supply power to components of the reception processing unit when the reception processing unit is in the operation state.

14. A method for managing awake-up of a device, the method comprising:
detecting a wake-up signal in a wireless signal by an activation control unit;
generating a first activation control signal and a second activation control signal, in response to the wake-up signal;
transitioning a reception processing unit from a sleep state into an operation state in response to the first activation control signal, the reception processing unit generating an output by down-converting the wireless signal and demodulating the down-converted wireless signal; and
transitioning the device from a sleep state to an operation state in response to the second activation control signal, the device processing the output of the reception processing unit.

15. The method according to claim 14, wherein generating the first activation control signal occurs at or nearly at the same time as generating the second activation control signal.

16. The method according to claim 14, further comprising, upon detecting completion of the reception of the wireless signal:
generating a first sleep signal and a second sleep signal;
placing the reception processing unit in a sleep state in response to the first sleep signal; and
placing the device in a sleep state in response to the second sleep signal.

17. The method according to claim 14, wherein
the wake-up signal continues for a certain time period; and
the reception processing unit and the device are enabled to transition into the operation state when the wake-up signal is received by the activation control unit within the certain time period.

18. The method according to claim 14, wherein
the device is configured to send an enable signal to the reception processing unit;
transitioning the reception processing unit from the sleep state to the operation state includes activating a timer with a predetermined expiration period; and
transitioning the reception processing unit from the operation state to the sleep state if the enable signal is not received prior to expiration of the timer.

19. The method according to claim 18, further comprising:
resetting the device after placing the reception processing into the sleep state.

20. The method according to claim 14, wherein the reception processing unit includes a regulator configured to supply power to components of the reception processing unit when the reception processing unit is in the operation state.
